(19) United States
(12) Patent Application Publication
(10) Pub. No.: US 2026/0049473 A1
(43) Pub. Date: Feb. 19, 2026

(54) COMPOSITE MESH

(71) Applicant: LIMITED LIABILITY COMPANY COMPOSITE GROUP CHELYABINSK, Chelyabinsk (RU)

(72) Inventor: Oleg Yurievich BELIAEV, Chelyabinsk (RU)

(21) Appl. No.: 19/100,951

(22) PCT Filed: Dec. 14, 2022
(86) PCT No.: PCT/RU2022/000372

§ 371 Date: Feb. 4, 2025

(30) Foreign Application Priority Data
Aug. 8, 2022 (RU) 2022121505

(51) Int. Cl. E04C 5/07

(52) U.S. Cl. CPC E04C 5/07

(57) ABSTRACT

The utility model relates to the production of fiber-reinforced polymer mesh made of non-metallic materials, used for reinforcing masonry and brickwork, concrete structures, for soil reinforcement, as well as for fencing and increasing the service life of roads.

The task of the utility model is to create a FRP mesh having high consumer characteristics, physical and mechanical properties, while ensuring high axial tensile strength of both longitudinal and transverse rods.

The FRP mesh is made of longitudinal and transverse rods connected to each other in accordance with the principles of the utility model; the mesh cell zone is formed by connecting cured and uncured rods at a right angle with subsequent curing of the mesh, in that case the connection of rods is carried out by feeding bundles of roving strands belonging to the formed longitudinal rod that are divided into strands of unequal thickness, are oriented perpendicularly to the longitudinal axis of the transverse rod and cover areas of its radial surface on opposite sides, which leads to the formation of cavities between rectilinear sections of the longitudinal rod and the surface of the transverse rod (FIG. 6, Table 2)

### FIELD OF THE DISCLOSURE

The utility model refers to the production of FRP mesh from non-metallic materials used for reinforcing masonry and brickwork, concrete structures, for soil reinforcement, as well as for fencing and increasing the service life of roads.

### BACKGROUND OF THE DISCLOSURE

FRP rod joints are known from the prior art [RF Patent No. 2404892 MPC B29/C 55/30, RF Patent No. 2430221 MPC E04C 5/07], in which intersected FRP rods are connected by squeezing and subsequent heating of rods and nodes.

The disadvantage of this connection includes insufficient strength and reliability of the node, especially under the influence of alternating loads.

The prior art [RF Patent No. 171181 MPK E04C5/07] describes a node of FRP rod that is formed by contacting cured and uncured rods at an angle with subsequent curing of the mesh, in that case the rods are connected in the contact zone by squeezing and gluing with polymer. The rods are connected by passing one rod (the inner one) through the structure of the other (the outer one), in that case the rod contact zone is located on both sides of the longitudinal axis of the outer rod and on the two opposite sides of the inner rod: moreover, the cavities between the rectilinear sections of the outer rod and the surface of the inner rod are partially or completely filled with the polymer.

The disadvantage of that type connection is that it is made by passing the inner rod through the structure of the outer rod, so there the fibres of the outer rod are split into equal bundles, which makes the product brittle due to a small area of contact, only a half of the rod works in case of a breaking axial load and splitting of the product at the joints becomes possible.

The closest technical solution is a FRP mesh from non-metallic materials [RF Patent RU 2714060 MPK E04C 5/073] in which the mesh cell zone is formed by ribbon of roving strands belonging to the formed longitudinal rod that are directed to the longitudinal axis of the transverse rod and cover its surface on the opposite sides of the horizontal plane passing through its longitudinal axis.

The disadvantage of that connection is that the longitudinal elements made from twisted ribbons of equal width make the end product brittle due to a small area of contact, since only a half of the rod is working in case of a breaking axial load and splitting of the product at the joints becomes possible.

The task of the utility model is to create a FRP mesh having high consumer characteristics, physical and mechanical properties and ensure that both longitudinal and transverse rods become highly resistant to axial tension.

### SUMMARY OF THE DISCLOSURE

The assigned task is achieved by the fact that the FRP mesh is formed by longitudinal and transverse rods connected in accordance with the utility model, the mesh cell zone is formed by connecting cured and uncured rods at a right angle with subsequent curing of the mesh: in that case the connection of rods is carried out by feeding bundles of roving strands belonging the formed longitudinal rod that are split into strands of unequal thickness, are oriented perpendicularly the longitudinal axis of the transverse rod and cover segments of its radial surface on opposite sides, which leads to the formation of cavities between rectilinear sections of the longitudinal rod and the surface of the transverse rod.

In a particular case, the mesh cells are square-shaped.

In a particular case, the mesh cells have a smooth or abrasive coating.

In a particular case, the transverse rod is distinguished by a periodic profile (a rib).

In a particular case, roving strands of a single bundle are split as follows: 5-15% of the roving form one part and 85-95% of the roving form the second part.

With that method of mesh cell formation, the transverse rod is securely fixed by the longitudinal rod, moreover, the contact zone is formed on both sides of the transverse rod and is located on both sides of the longitudinal axis of the longitudinal rod. That method ensures an even reliability of mesh cell knot in the direction perpendicular to the mesh plane, which will lead to a high axial tensile strength. The high tensile strength is achieved by placing more strands on one side: when stretching along the longitudinal trajectory occurs, the areas with a larger amount of strands will work and warping of the end product (mesh) surface is prevented.

Cavities between rectilinear sections of the longitudinal rod and the surface of the transverse rod guarantee penetration of mortar and, when fixing the mesh in concrete, a monolithic structure of the entire building construction is achieved.

### BRIEF DESCRIPTION OF THE DRAWINGS

The technical solution is explained by graphs and an example of FRP mesh manufacture.

FIG. 1 presents a general view of the mesh with square-shaped cells.

FIG. 2 presents a diagram of the connection zone of FRP rods in a cross-section of the transverse rod.

FIG. 3 presents a diagram of the connection zone of FRP rods in a cross-section of the longitudinal rod.

FIG. 4 presents the knot of mesh formation and weaving.

FIG. 5 presents a diagram on the axial tension of the longitudinal rod in case of an unequal distribution of fibre around the transverse rod.

FIG. 6 is a diagram of axial tension of the longitudinal rod in case of an equal distribution of fibre around the transverse rod.

### DETAILED DESCRIPTION OF THE DISCLOSURE

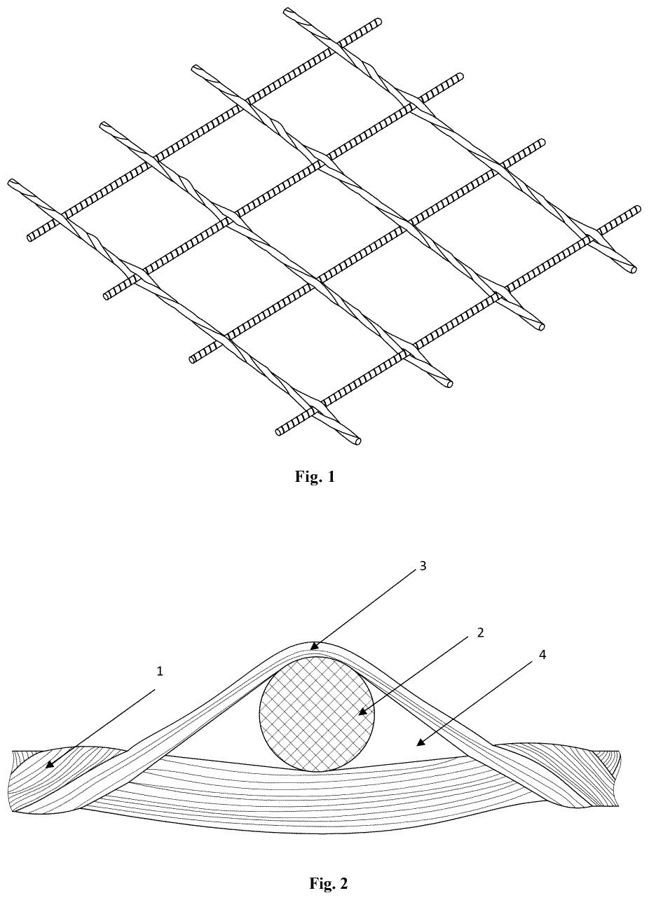

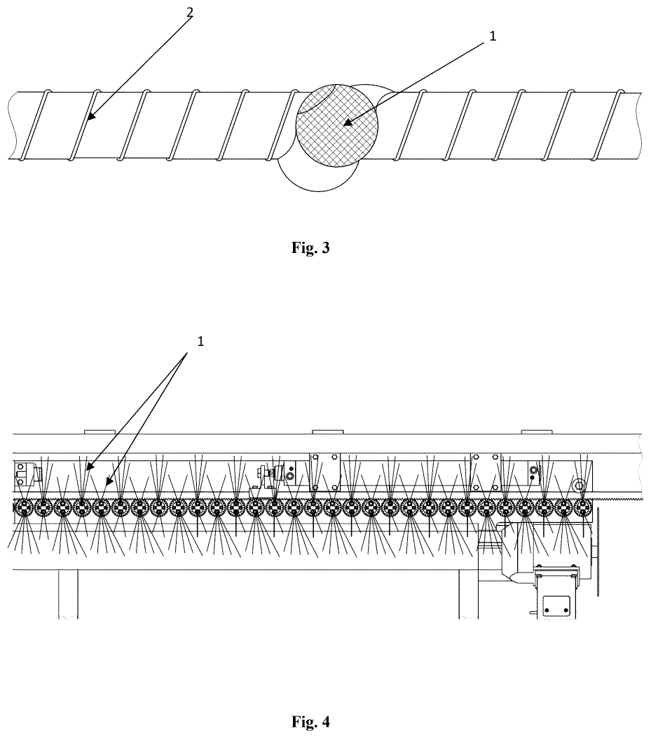

The FRP mesh is made of longitudinal (1) and transverse (2) rods (FIG. 1). The mesh cell zone is formed by a cured transverse rod (2) and a longitudinal rod (1) connected at a right angle. The contact zone (3) is located on both sides of the longitudinal axis of the longitudinal rod (1), as well as on the two opposite sides of the transverse rod (2). As a result of the longitudinal rod (1) weaving around the transverse rod (2), the cavities (4) are formed (FIG. 2). The longitudinal rod (1) has a variable cross-section: it is round in the middle (FIG. 3) and flat in the contact zone (3) in the area a joint with the transverse rod (2).

The connection of the rods is carried out as follows.

Roving threads pass through three parallelly-positioned impregnation-and-pressing units, where the roving is impregnated with a compound and the excess compound is squeezed out at the output of the unit. One unit is designed to impregnate roving strands of the transverse rods, the other two are used to impregnate longitudinal roving strands.

The impregnation-and-pressing units are followed a periodic profile forming device for the transverse rod. Roving strands, passing through that unit, are joined to form a transverse rod, on which a periodic profile is applied. The transverse then enters a separate section of the polymerization chamber where curing at high temperatures takes place. Passing through a water cooling unit, the transverse rod is fed onto a return wheel that reverses the direction of transverse rod movement.

To ensure further continuous movement of the transverse rod, a cross bar pulling unit is used. Having passed through it, the transverse rod gets into a separator (a device designed for distribution, accumulation and feeding of rods into the FRP mesh forming and weaving unit).

Having passed the impregnation-and-pressing unit, roving of the longitudinal rod is directed into the FRP mesh forming and weaving unit (FIG. 4), there roving bundles of longitudinal rods are formed. The roving used to form a longitudinal rod enters openings in gears and is split into two bundles, where, for example, 5% of the roving form one bundle and 95% of the roving form another bundle, and so on. The gears are designed with grooves between the openings, the transverse rod is fed into the grooves by two rotating polyurethane-coated wheels.

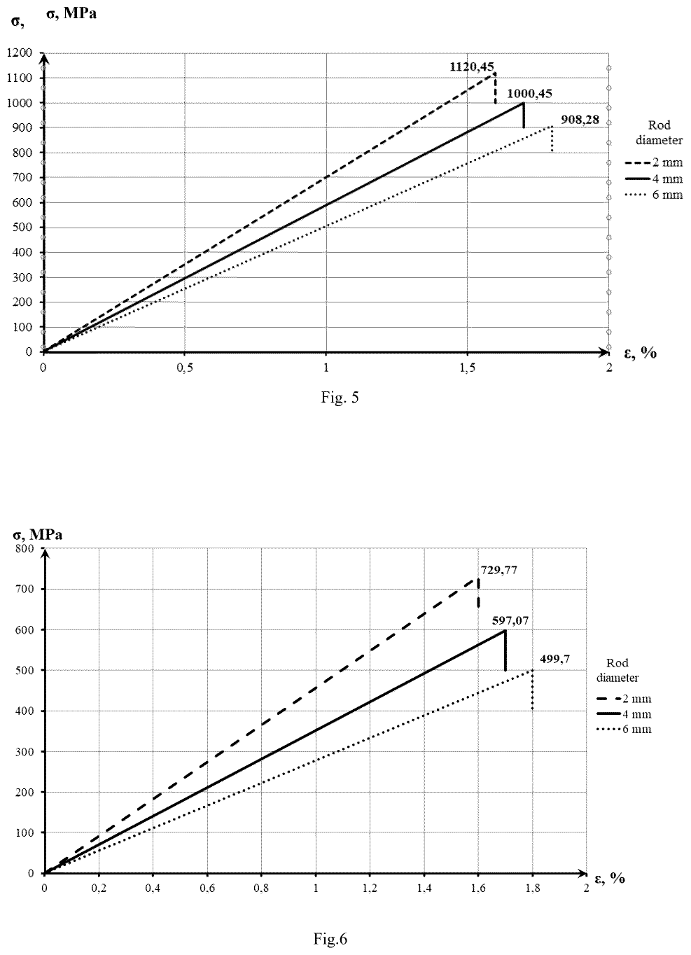

Tests have shown (Table 1, Table 2, FIG. 5, FIG. 6) that splitting the roving of the longitudinal rod (2 mm, 4 mm and 6 mm in diameter) into unequal bundles and distributing it around the transverse rod results in an average axial tensile strength of 900-1100 MPa.

The proposed FRP mesh is distinguished by high consumer characteristics, enhanced physical and mechanical properties and ensures high axial tensile strength in all directions.

TABLE 1
Test results on axial tension of a longitudinal FRP mesh rod in case
of an unequal distribution of its bundles around a transverse rod

| | | | Ultimate axial tensile strength, MPa | | |
|---|---|---|---|---|---|
| | | | | | Norm according |
| | Nominal | | | | to Table 4 |
| No. of | diameter, | Breaking | Actual | | GOST R |
| specimen | mm | load, N | value | Average | 58964-2020 |

Longitudinal rod of FRP mesh, Ø 2 mm

| | | | | | |
|---|---|---|---|---|---|
| 1 | 2.04 | 4023 | 1231.46 | 1120.45 | 800 |
| 2 | 2.11 | 3892 | 1113.62 | | |
| 3 | 2.05 | 3954 | 1198.56 | | |
| 4 | 2.16 | 3687 | 1006.69 | | |
| 5 | 2.19 | 3250 | 863.23 | | |
| 6 | 2.01 | 4152 | 1309.17 | | |

Longitudinal rod of FRP mesh, Ø 4 mm

| | | | | | |
|---|---|---|---|---|---|
| 1 | 4.09 | 13211 | 1006.05 | 1000.45 | 800 |
| 2 | 4.1 | 13109 | 993.42 | | |
| 3 | 4.06 | 13328 | 1030.01 | | |
| 4 | 4.03 | 12942 | 1015.13 | | |
| 5 | 4.13 | 12812 | 956.86 | | |
| 6 | 4.14 | 13471 | 1001.22 | | |

Longitudinal rod of FRP mesh, Ø 6 mm

| | | | | | |
|---|---|---|---|---|---|
| 1 | 6.07 | 26175 | 904.98 | 908.28 | 800 |
| 2 | 6.12 | 26863 | 913.65 | | |
| 3 | 6.01 | 26154 | 922.40 | | |
| 4 | 6.05 | 26327 | 916.26 | | |

TABLE 2
Test results on axial tension of a longitudinal FRP mesh rod in case
of an equal distribution of its bundles around a transverse rod

| | | | Ultimate axial tensile strength, MPa | | |
|---|---|---|---|---|---|
| | | | | | Norm according |
| | Nominal | | | | to Table 4 |
| No. of | diameter, | Breaking | Actual | | GOST R |
| specimen | mm | load, N | value | Average | 58964-2020 |

Longitudinal rod of FRP mesh, Ø 2 mm.

| | | | | | |
|---|---|---|---|---|---|
| 1 | 2.14 | 2512 | 698.75 | 729.77 | 800 |
| 2 | 2.12 | 2647 | 750.26 | | |
| 3 | 2.22 | 2187 | 565.29 | | |
| 4 | 2.19 | 2891 | 767.87 | | |
| 5 | 2.13 | 2638 | 740.71 | | |
| 6 | 2.01 | 2714 | 855.75 | | |

Longitudinal rod of FRP mesh, Ø 4 mm.

| | | | | | |
|---|---|---|---|---|---|
| 1 | 4.19 | 8117 | 588.98 | 597.07 | 800 |
| 2 | 4.14 | 7824 | 581.51 | | |
| 3 | 4.08 | 7958 | 609.00 | | |
| 4 | 4.03 | 7658 | 600.67 | | |
| 5 | 4.15 | 8201 | 606.60 | | |
| 6 | 4.11 | 7899 | 595.69 | | |

Longitudinal rod of FRP mesh, Ø 6 mm.

| | | | | | |
|---|---|---|---|---|---|
| 1 | 6.14 | 14691 | 496.42 | 499.70 | 800 |
| 2 | 6.18 | 14857 | 495.55 | | |
| 3 | 6.03 | 14922 | 522.78 | | |
| 4 | 6.08 | 14711 | 506.95 | | |
| 5 | 6.17 | 14405 | 482.03 | | |

1. The FRP mesh is made of longitudinal and transverse rods connected with each other, it is distinguished by mesh cell zone formation by cured transverse and uncured longitudinal rods connected at right angles with subsequent curing of the mesh, and the connection of rods is carried out by feeding bundles of roving strands belonging to the formed longitudinal rod that are divided into strands of unequal thickness, are oriented perpendicularly to the longitudinal axis of the transverse rod and cover sections of its radial surface on opposite sides, cavities between the rectilinear sections of the longitudinal rod and the surface of the transverse rod are formed.

2. The FRP mesh produced according to claim 1 is distinguished by square-shaped cells.

3. The FRP mesh produced according to claim 1 is distinguished by mesh cells that have smooth or abrasive coating.

4. The FRP mesh produced according to claim 1 is distinguished by a periodic profile (rib) applied to the transverse rod.

5. The FRP mesh produced according to claim 1 is made of roving strands split in bundles as follows: 5-15% of the roving form one bundle and 85-95% of the roving form the second bundle.
